(19) United States
(12) Patent Application Publication
(10) Pub. No.: US 2012/0092114 A1
(43) Pub. Date: Apr. 19, 2012

(54) POWER TRANSFORMER CONDITION MONITOR

(76) Inventor: Kenneth R. MATTHEWS, CORONA, CA (US)

(21) Appl. No.: 13/271,688

(22) Filed: Oct. 12, 2011

Related U.S. Application Data
(60) Provisional application No. 61/393,700, filed on Oct. 15, 2010.

(51) Int. Cl. H01F 27/00

(52) U.S. Cl. 336/107

(57) ABSTRACT

Improvements in a power transformer condition monitor are disclosed with this application. The monitor operates with older existing transformers with and without integrated sensors and allows the device to determine the condition of transformers. The sensors monitor one or a multiple of voltage, current, temperature and or power factor. Thermal sensors are magnetically attached to the exterior of the power transformer. Voltage and current sensors are connected to the primary and secondary conductive wires. The monitor can be parasitically powered to operate with limited battery size. The only use of batteries or storage capacitors is when the supply voltage is lost. The monitor uses a localized board can have a large plurality of inputs for sensors. This allows multiple transformers to be locally connected to the monitor and thereby reduce the number of different communication devices and communication addresses over a Mesh, GPRS Cell network link network.

### CROSS REFERENCE TO RELATED APPLICATION

This application claims the benefit of Provisional Application Ser. No. 61/393,700 filed Oct. 15, 2010 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a monitor for power transformers. More particularly, the present Power Transformer Condition Monitor can be connected to an existing power transformer that was not built with monitoring capability. Sensors are magnetically connected to the outside surface of the transformer and are electrically or inductively connected to the power lines to monitor the power transformer. The information is stored and or transmitted to an external monitoring station using wireless transmission. Furthermore, the device can be powered via battery or via energy harvesting from its operating environment.

2. Description of Related Art Including Information Disclosed Under 37 CFR 1.97 and 1.98

Power transformers are used to reduce the voltage of the power lines to a lower voltage where the lower voltage is used in a house or business. In summer months the use of air conditioners, appliances and other equipment require some of the highest demands from the power transformers. Newer power transformers are built with internal sensors to monitor the temperature of the transformer. Several products and patents have been issued that address monitoring the condition of power transformers. Exemplary examples of patents covering these products are disclosed herein.

U.S. Pat. No. 5,078,078 issued Jan. 7, 1992 to Nikola Cuk discloses a transformer internal fault warning indicator. The indicator is a cap that reacts to a transient over-pressure event. The tap moves to when a transient occurs. The movement of the cap can be visibly seen by a repair technician. This patent does not include a monitoring system that transmits the status of the transformer. This patent only identifies that transformer has faulted after the fault has occurred.

U.S. Pat. Nos. 7,140,237 and 7,222,528 both issued to Manabu Dohi et al in Nov. 28, 2006 and May 29, 2007 respectively disclose a Transformer monitoring system. These patents rely upon monitoring the current of the transformer and the ambient temperature. These factors are used with a mathematical algorithm to predict a potential overload or failure of the transformer. This patent does not provide actual data from the transformer and further uses analysis of ambient outside temperature that is often not accurate for a transformer that is in direct sunlight verses a transformer that is in the shade or underground.

U.S. publication number 2008/0088462 that was published on Apr. 17, 2008 to David S. Breed discloses Monitoring Using Cellular Phones. The monitoring information from at least one sensor is communicated to the cellular phone where it is then sent from the cellular phone to a monitoring location. While this publication monitors a sensor and the information is the communicated, the sensor is not from a power transformer and further the number of transformers could outnumber the available phone numbers. Communication over a cellular network further has limitations for up-scaling to communicate with every power transformer.

U.S. publication US2006/0251147 was published on Nov. 9, 2006 and U.S. Pat. No. 7,377,689 that was published on May 27, 2008 were both invented by Todd-Michael Balan disclose Transformer Temperature Monitoring and Control. These documents disclose using a sensor that is installed within the core's winding when the transformer is fabricated. While the internal core oil temperature can be obtained when the sensor is installed upon fabrication of the transformer the internal sensor is not available in older transformers.

What is needed is a power transformer condition monitor that can be installed onto a transformer that is built without internal sensors. This application for patent provides the solution with a power transformer conditioning monitor that uses sensor that are securable to exterior of an existing transformer using magnets and communicating the condition of the power transformer using wireless network and the ability to be powered via battery or via energy harvesting from its operating environment.

### BRIEF SUMMARY OF THE INVENTION

It is an object of the power transformer condition monitor to operation with existing transformers. The need to operate with existing transformers allows the device to determine the condition of transformers that have been installed for many years as well as allow for installation on transformers where the internal sensor(s) have failed. Transformers have been in use for over 100 years and some old transformers are still in use in some installations. These older transformers were a simple construction of a primary and a secondary winding on an iron core. They lacked any sensors to determine a potential for the condition of the transformer.

It is an object of the power transformer condition monitor to monitor one or a multiple of voltage, current, temperature, harmonics, and real and reactive power and/or power factor. Each of these factors provides information on the condition of the transformer and the potential for near or long term failure of the transformer. In many conditions multiple transformers are positioned near each other and the power transformer condition monitor can monitor the transformers both individually and collectively.

It is an object of the power transformer condition monitor to use sensors that are magnetically coupled to the exterior of the power transformer. Attaching these sensors to the exterior of the transformer eliminates modification of the closed/sealed transformer that can cause damage to an older transformer. Magnetically attached sensors can be easily positioned or repositioned to collect data from a hotter or colder area. The hot or cold area can be identified by a thermal camera or thermocouple. Connection to the primary and secondary can be simply clipped onto the power terminals. A current sensor can monitor the voltage drop along the conductive wires.

It is an object of the power transformer condition monitor to operate as a parasitic device as it is connected to the primary, secondary or inductively couple with the transformer. Powering the monitor as a parasitic device allows the monitor to operate with limited battery size. Where the only use of batteries or storage capacitors is when the transformer or supply voltage is lost.

It is another object of the power transformer condition monitor for the monitor to have a localized board for multiple sensors. The localized board can have a large plurality of inputs for sensors. This allows multiple transformers to be locally connected to the monitor and thereby reduce the number of different communication devices and communication addresses.

It is still another object of the power transformer condition monitor to communicate through GPRS Cell Network. The communications network can be a Mesh, GPRS Cell network link or other similar network that allows for communication and monitoring multiple transmitters. Furthermore, the device can be powered via battery or via energy harvesting from its operating environment.

Various objects, features, aspects, and advantages of the present power transformer condition monitor will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a typical installation of multiple power transformers with a condition monitor.

FIG. 2 shows an exterior view of the condition monitor.

FIG. 3 shows a perspective view of the condition monitor with transparent side walls to show the interior construction.

FIG. 4 is a block diagram showing the internal functions of the condition monitor.

FIG. 5 shows a bottom side application of the condition monitor on a transformer.

FIG. 6 shows installation of the condition monitor on the bottom of a single transformer.

### DETAILED DESCRIPTION OF THE INVENTION

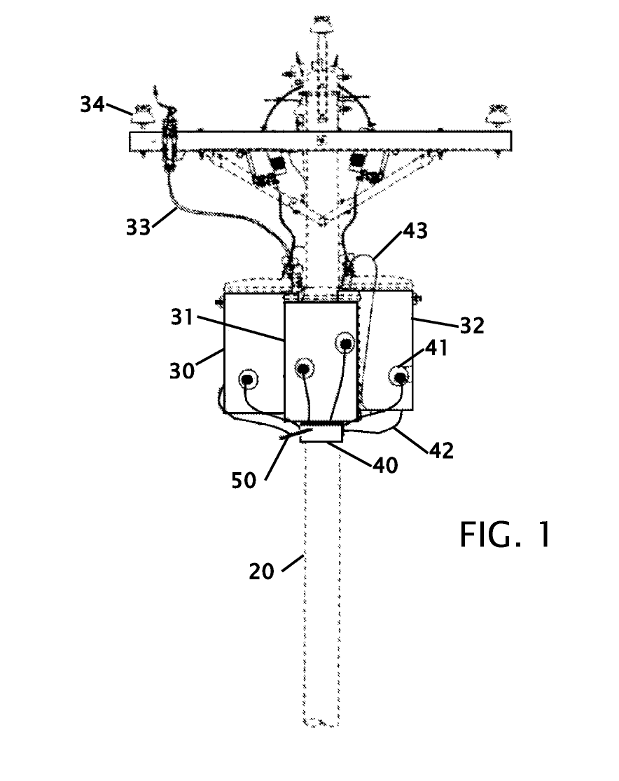

FIG. 1 shows a typical installation of multiple power transformers with a condition monitor. The condition monitor 40 is shown attached to the underside of the transformers 30, 31 and 32 that are mounted on a power pole 20. The transformers receive electrical power from wires that are secured to insulators 34 that connect 33 to the transformer(s). The condition monitor 40 deploys sensors 41 on transformers 30, 31 and 32 that are magnetically attached to the transformer(s) to detect temperature readings in increments that are set by the operator wirelessly through the network. Current units are capable of handling a minimum of six (6) plug-in sensors with an internal sensor that are wired 42 to the condition monitor 40 and used to monitor temperature of the transformer(s) along with the ambient air temperature. Additional sensors can be wired to the power connection of the transformer primary and or secondary power connection 43 to measure voltage, current or power factor. The board 40 further has a plug-in antenna 50 that is used to improve reception and communications with cellular tower or mesh communication node.

In a majority of cases, it is enough to supply a reliable warning signal without online analysis and diagnosis, provided that manual or automatic diagnostic methods are available to follow up the alarm. Specifically with regard to power distribution networks in the US, a majority of the transformer population is aging, and most emerging faults can be expected from these units. Monitoring equipment should thus be designed for field installation on operational transformers that might date back a few decades. Transformers are the lifeline to the electrical grid and as a vital part of transmission and distribution systems, transformers are built and expected to be unfailingly reliable. Nevertheless, internal faults like partial discharges can occur, and the problem with such faults is that if left un-corrected, they can eventually morph into catastrophic faults that can result in power outages and even end-user property damage.

Preventing disasters of this nature is actually quite simple, and involves transformer monitoring. Monitoring transformers and spotting problems before they turn into unmanageable incidents can prevent faults that are costly to fix and may result in a loss of service. Transformer monitoring mainly involves data acquisition, sensor development, data analysis, and the development of causal links between measured values and failures of transformers.

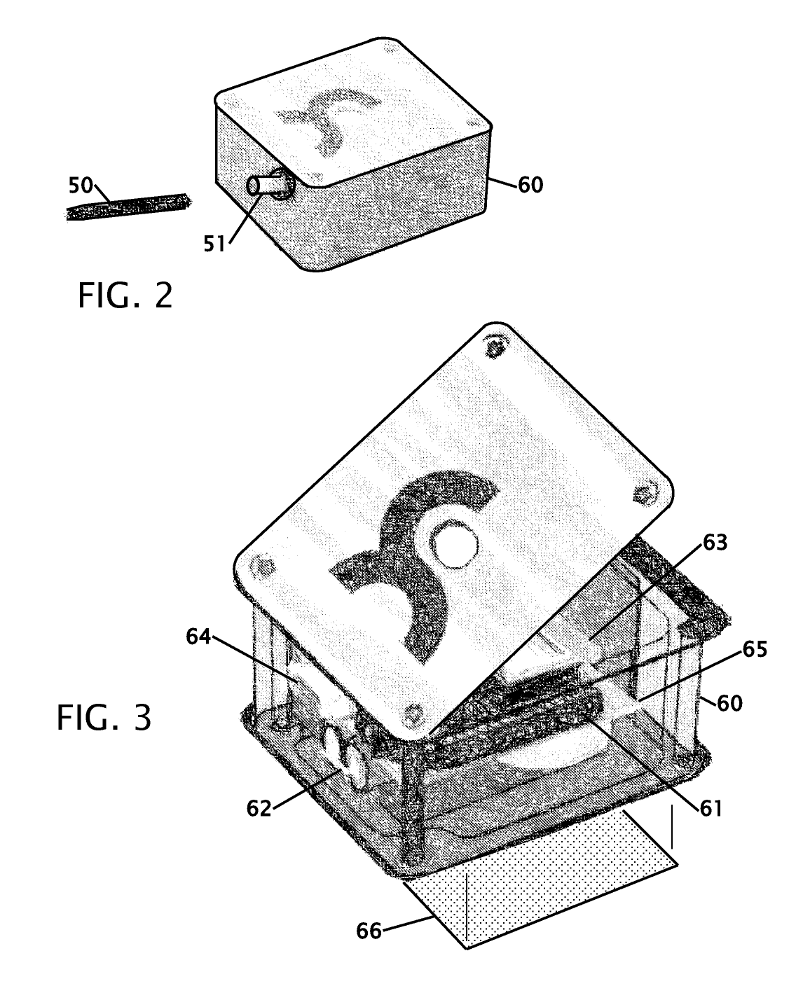

FIG. 2 shows an exterior view of the condition monitor and FIG. 3 shows a perspective view of the condition monitor with transparent side walls to show the interior construction. The system is an all-in-one solution for embedded wireless control and monitoring in a single housing 60 having an integrated or an external antenna 50 that connects to a connector 51. Power is applied to the module and the module is connected to a cellular and or mesh network, the module includes sensor connections 61 that include but are not limited to a wireless serial port, a thermal sensor, humidity sensor, vibration sensors, GPS sensors, voltage sensor, current sensor, actuator control or an intelligent embedded controller.

The sensors can monitor not only a transformer but is also capable of monitoring, data collection and monitoring any measurable commodity including but not limited to electricity, gas, oil and audible data. The data is locally stored on the device for communications to a communications command is requested. When the communication is transmitted previous transmitted data can be retained, appended or stored. The device can also perform API or AI with the data to autonomously make changes to future readings, reports or collection of the data. It is also contemplated that the device can make changes to the supply of the commodity.

The sensing device is capable of sustaining its operation via a rechargeable battery source 62 and/or energy source harvested from its operating environment, in the form of electrical, magnetic, thermal, solar or mechanical energy.

The wireless network technology combines Smart Grid data streams with a wide variety of other applications including but not limited to video surveillance, public safety communications, traffic signal controls and public access WiFi networks to bridge the digital divide.

The sensor board 65 is specifically designed for this application to provide optimal performance, power, reliability and form factor. The design is modular and will allow for future upgrades to support additional sensors along with other types of sensors such as vibration and humidity. The temperature sensor can be digital or resistance. Digital sensors are preferred because they do not require calibration. The elimination of calibration improves temperature sensor reliability due to electrical interference and noise to provide reading accuracies of +/−3 degrees over an operational temperature of −40 Degrees C. to +125 degrees C. On-board batteries 62 can supply limited power to the sensor board 65. The housing can be fabricated with a magnet 66, hook and loop fasteners or other similar means that allows the housing to be easily and rigidly mounted to a side of the transformer.

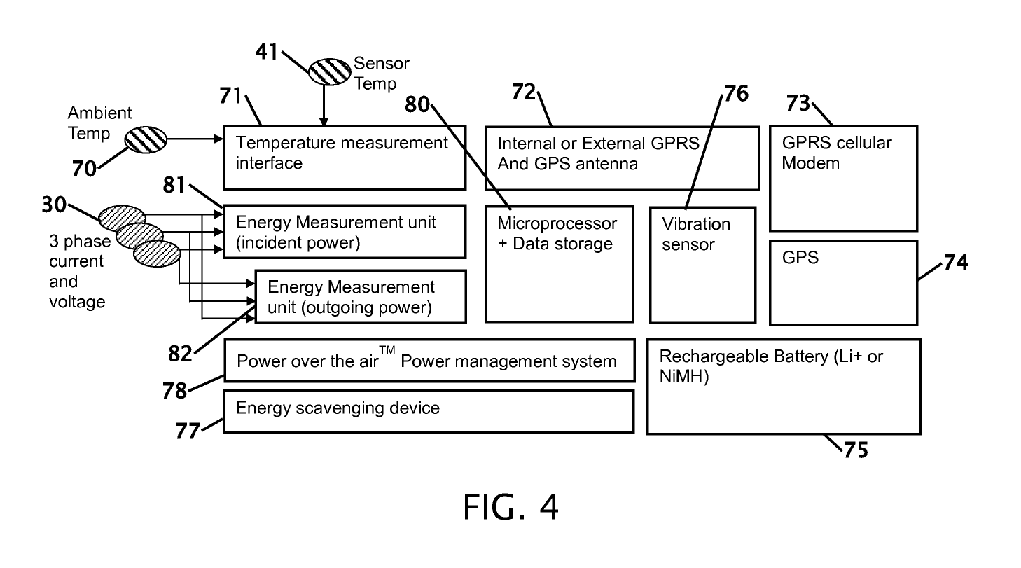

FIG. 4 is a block diagram showing the internal functions of the condition monitor. The system has a robust security features for extensive data security that is capable of providing WEP, WPS, WPA2, 128 bit AES encryption, 802.11i and FIPS 140-2 using a GPRA cellular modem 73. Extensive VLAN and performance-tuning features are also standard, including support for 802.11e (for radio level QoS) protocol-based forward, and hidden SSID's. The system uses power over the air power management system 78. In the preferred embodiment the system is powered with energy that is scavenged 77 from the transformer or the power that is applied to the transformer(s). A rechargeable battery 75 provides back-up or emergency power if scavenging power 77 is not available due to a power outage.

The base system uses a dual sensor device with mesh and/or a cellular network operating system that provides embedded intelligence and wireless communication for connecting devices with other devices or people. Signal from the temperature sensors 41 that are magnetically attached to the exterior of the transformer are measured by the temperature measurement interface 71 the ambient temperature 70 is also measure with the same module 71. The information from the 3 phase current and voltage 30 is measured from both the energy measurement unit (incident power) 81 and the energy measurement unit (outgoing power) 82. A microprocessor and data storage unit 80 controls all of the internal calculations and operations as well as communications through an internal or external GPRS and GPS antenna 72. It is contemplated that each unit include a GPS locator 74 to identify the global location of the system to eliminate the need for a technician to log the device serial number and the geographic location. It is further contemplated to include a vibration sensor 76 or other sensors the further enhance the functionality and testing capability of the system.

The devices can be reprogrammed remotely which allows the asset owner to implement changes in operation functionality without effecting the current operational environment. The device functionality changes can then be activated in a controlled manner with full rollback capability to ensure they do not become stranded, thereby reducing the risk by enabling the rollout of updates in remote locations.

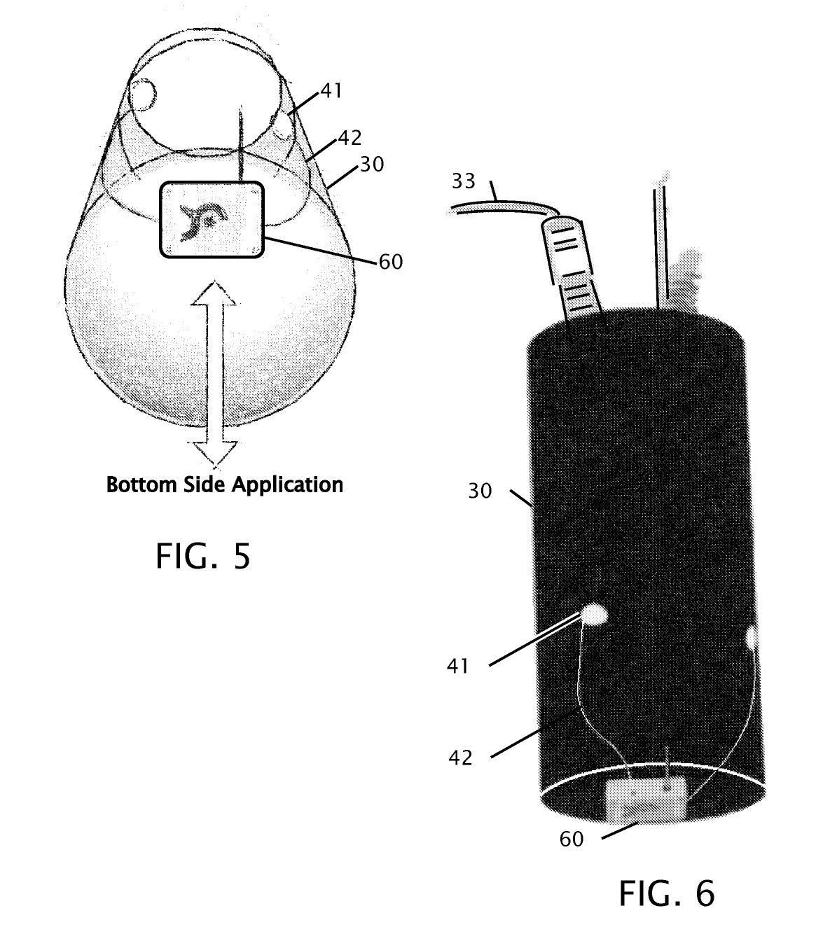

FIG. 5 shows a bottom side application of the condition monitor on a transformer and FIG. 6 shows installation of the condition monitor 60 on the bottom of a single transformer 30. In the preferred embodiment the device is mounted on the transformer and is online 24/7. The reliable low-cost monitoring is a necessary condition. Transformers have a typical failure rate of 0.2 to 2.0 per transformer/year and monitoring all of the installed transformers must be accomplished at a cost effective rate. These figures show the incoming power connection 33 to the transformer 30. The temperature sensors 41 are magnetically attachable to the transformer and wired 42 to the condition monitor 60.

Thus, specific embodiments of a power transformer condition monitor have been disclosed. It should be apparent, however, to those skilled in the art that many more modifications besides those described are possible without departing from the inventive concepts herein. The inventive subject matter, therefore, is not to be restricted except in the spirit of the appended claims.

1. A power transformer condition monitor comprising:
at least one sensor that connects to a power transformer that is electrically connected one side to a power supply and at least on a second side to at least one power usage device;
said at least one sensor being connected to a communications node;
said communications node provides measurements information on at least measurement from said power transformer, and
said communications node is at least partially powered by a battery or by energy harvesting from its operating environment.

2. The power transformer condition monitor according to claim 1 wherein said harvesting is by coupling to said power transformer.

3. The power transformer condition monitor according to claim 1 wherein said communications node is a GPRS cell network link.

4. The power transformer condition monitor according to claim 1 wherein said communications node is over power supply or power usage lines.

5. The power transformer condition monitor according to claim 1 wherein said power supply is a power generating station.

6. The power transformer condition monitor according to claim 1 wherein said power usage device is a residence or building.

7. The power transformer condition monitor according to claim 1 wherein said sensor is selected from a group including a temperature sensor, a current sensor and a voltage sensor.

8. The power transformer condition monitor according to claim 3 wherein said temperature sensor further includes a magnet for temporally connecting to said transformer.

9. The power transformer condition monitor according to claim 1 wherein said communicating node uses a previously established widely used, and deployed communication infrastructure, such as a cellular network, for communicating, for data retrieval, for sending alert signal to any portable devices, which are part of a public communication infrastructure.

10. The power transformer condition monitor according to claim 1 wherein said sensing device provides at least one environmental measurement.

11. The power transformer condition monitor according to claim 1 wherein said power transformer condition monitor provides sustaining operation via a rechargeable battery source that is charged by energy harvested from its operating environment, in the form of electrical, magnetic, thermal, solar or mechanical energy.

12. The power transformer condition monitor according to claim 11 wherein said energy harvesting is with a non-contact sensing function as part of the energy harvesting scheme.

13. The power transformer condition monitor according to claim 1 wherein said measurement is at least one of input voltage, output voltage, current, power factor, vibration sensor, ambient temperature and transformer core temperature.

14. The power transformer condition monitor according to claim 1 that further includes a local data storage capability until said local data storage is requested in a transmission.

15. The power transformer condition monitor according to claim 1 that further includes a GPS locator to identify a global location of a power transformer condition monitor.

16. The power transformer condition monitor according to claim 1 wherein an operating software within said monitor can be reprogrammed remotely.

17. The power transformer condition monitor according to claim 1 that further includes data security that is capable of providing WEP, WPS, WPA2, 128 bit AES encryption, 802.11i and FIPS 140-2 using said GPRA cellular modem.

18. The power transformer condition monitor according to claim 1 further includes a plug-in antenna or an integrated antenna.

19. The power transformer condition monitor according to claim 1 that further uses communication addresses over a Mesh, GPRS Cell network link network.

20. The power transformer condition monitor according to claim 1 further performs API or AI with data to autonomously make changes to future readings, reports or collection of said data.
